(19) United States
(12) Patent Application Publication
(10) Pub. No.: US 2023/0039900 A1
(43) Pub. Date: Feb. 9, 2023

(54) METHOD FOR REALIZING A MULTI-CHANNEL CONVOLUTIONAL RECURRENT NEURAL NETWORK EEG EMOTION RECOGNITION MODEL USING TRANSFER LEARNING

(71) Applicant: FUZHOU UNIVERSITY, Fuzhou (CN)

(72) Inventors: Liang-Hung Wang, Fuzhou (CN); I-chun Kuo, Fuzhou (CN)

(73) Assignee: FUZHOU UNIVERSITY, Fuzhou (CN)

(21) Appl. No.: 17/706,627

(22) Filed: Mar. 29, 2022

(30) Foreign Application Priority Data
Aug. 7, 2021 (CN) 202110904775.1

(51) Int. Cl. G06N 3/08

(52) U.S. Cl. CPC G06N 3/08

(57) ABSTRACT

The invention provides a method for realizing a multi-channel convolutional recurrent neural network EEG emotion recognition model using transfer learning, the method uses a dual-channel one-dimensional convolutional neural network model constructed based on three heartbeats recognition method as the source domain model for transferring, to obtain a multi-channel convolutional recurrent neural network EEG emotion recognition model with EEG signal as the target domain, it solves the problem of scarcity of EEG labeling data, and can improve the accuracy of EEG emotion prediction. The accuracy of data processing is improved by decomposing and normalizing the EEG data set; the transferred multi-channel convolutional neural network extracts the features of multi-channel EEG signals in EEG data set; combined with the recurrent neural network, sequence modeling is carried out to extract multi-channel fused emotional information; the feature redistribution is realized by adaptive attention model and weighted feature fusion, and the complete feature tensor is obtained.

### FIELD OF TECHNOLOGY

The invention belongs to the technical field of machine learning and transfer learning, in particular to a method for realizing a multi-channel convolutional recurrent neural network EEG emotion recognition model using transfer learning.

### BACKGROUND

Emotion is a general term for a series of subjective cognitive experiences, it includes people's psychological response to external stimulation or self-stimulation, as well as its accompanying physiological response. The essence of emotion is the individual's perceptual response to the things around him. Emotion plays a very important role in individuals themselves, between individuals and others, and between individuals and social life, so the research of emotion recognition is of great significance in theory and practical application. Electroencephalogram (EEG) is a medical imaging technology, which can measure and record the potential fluctuation on the scalp surface caused by the ionic current in the meridian element of the brain in chronological order. Research shows that people's cognitive behavior and psychological activities have a strong correlation with EEG signals, and people's emotional state can be predicted by measuring EEG signals.

At present, there is no ready-made algorithm model to deal with the above technical problems. For example, Chinese patent CN202010122175—three-beat multi-model comprehensive decision ECG feature classification method integrating the influence of source end provides a classification model of ECG data, but it cannot be directly used to deal with the classification of EEG signals.

### SUMMARY

In order to make up for the gaps and shortcomings of the prior art, the invention aims to provide a method for realizing a multi-channel convolutional recurrent neural network EEG emotion recognition model using transfer learning, it uses a dual-channel one-dimensional convolutional neural network model constructed based on three heartbeats recognition method provided by the Chinese patent CN202010122175—three-beat multi-model comprehensive decision ECG feature classification method integrating the influence of source end mentioned in the background technology as the source domain model for transferring, to obtain a multi-channel convolutional recurrent neural network EEG emotion recognition model with EEG signal as the target domain, it solves the problem of scarcity of EEG labeling data, improves the accuracy of EEG emotion prediction, and obtain the prediction results of EEG emotional signals on two indicators: valence and arousal.

The source domain model in the invention relates to another invention application of the inventor, Chinese patent CN202010122175—three-beat multi-model comprehensive decision ECG feature classification method integrating the influence of the source end, which has been published. The source domain model is a multi-lead three-beat ECG classification model designed based on the application of the invention, the corresponding flow chart of the model is shown in FIG. 1 of the description, the main architecture of the three beats classification method is a dual-channel one-dimensional deep convolution neural network. The network can automatically extract and analyze the subtle features that are difficult to be found manually in ECG signals, learn their feature correlation and classify them. The input of the dual-channel convolutional neural network is the three heartbeats ECG signal sequence of two different leads, which enters the convolutional layer from the two channels, and the feature tensor output by the convolutional layer enters the normalization layer (BN layer) for normalization. The normalization layer is followed by the activation layer, and the ReLU function is used as the activation function to increase the ability of the network to learn complex data. The residual network is introduced into the network, and the identity mapping is used to optimize the feedback to avoid the reduction of feedback gradient. The residual network is a cross layer superposition process, in which the number of channels does not match, resulting in the inability to stack directly, therefore, a user-defined layer named Lambda is added in the network design process, the number of channels is matched by filling data on the extra channels. The convolutional neural network superimposes the convolutional layer, normalization layer, activation layer and residual structure as a combination for several times, at the same time, in order to avoid over fitting of the network, some network units of random deactivation of dropout layer are added to the network. In this model, the convolutional layer is used to extract features, and the feature length is reduced several times according to the step size, and finally to the fully connected layer, then, through the activation layer using softmax function, the five ECG categories of N, V, S, F and Q are obtained. Adopting the above dual-channel one-dimensional deep convolutional neural network as the source domain model of the embodiment of this patent helps to solve the gradient disappearance and gradient explosion problems that are easy to occur in the multi-layer neural network in the emotion recognition process of EEG signals, and provides a technical basis for realizing the transfer learning scheme from source domain ECG signals to target domain EEG signals.

The main technologies applied include:
1) Improving the accuracy of data processing by decomposing and normalizing the EEG data set;
2) Extracting the features of multi-channel EEG signals in EEG data set by the transferred multi-channel convolutional neural network;
3) Carrying out sequence modeling to extract multi-channel fused emotional information combined with recurrent neural network;
4) Realizing the feature redistribution by adaptive attention model and weighted feature fusion, and obtaining the complete feature tensor, outputting the feature tensor by dual classifier to obtain the prediction results of EEG signals on two indicators: valence and arousal.

The invention specifically adopts the following technical solutions:

A method for realizing a multi-channel convolutional recurrent neural network EEG emotion recognition model using transfer learning, characterized in that it comprises the following steps:

Step S1: preprocessing the EEG data set such as noise reduction, decomposition and normalization;

Step S2: building a EEG feature extraction pre-training model, using a dual-channel one-dimensional convolutional neural network model constructed based on three heartbeats recognition method as the source domain model for fine-tuning training, using a one-dimensional convolutional neural network to extract the features of EEG signals of each channel, replacing the structure from the fully connected layer to the output layer with the average pooling layer, and outputting the high-level extracted features of EEG signals of each channel to obtain a multi-channel convolutional neural network.

Step S3: using the multi-channel convolutional neural network to extract the features of multi-channel EEG signals in EEG data set;

Step S4: obtaining the high-level features output by the multi-channel convolutional neural network, inputting the feature set into a recurrent neural network for sequence modeling, and outputting the feature set of the recurrent neural network;

Step S5: using an adaptive attention model and weighted feature fusion method to realize the redistribution of feature, and reconstructing to form a complete feature set with timing information;

Step S6: multi-classifying the feature set through the fully connected layer to obtain the prediction results of EEG emotional signals on two indicators: valence and arousal.

In the invention, the dual-channel one-dimensional convolutional neural network model based on three heartbeats recognition method is used as the source domain model to train the source domain model and realize the automatic classification of arrhythmias; the test set and the training set are strictly distinguished through the data set to realize the inter patient arrhythmia classification and improve the generalization ability of the model; by comparing and analyzing the similarities and differences between EEG and ECG, it conforms to the application scope of transfer learning, and uses transfer learning to realize the multi-channel convolutional recurrent neural network EEG emotion recognition model.

Further, step S1 specifically comprises the following steps:

Step S11: using wavelet basis function to decompose the EEG signals in the EEG data set by multi-level wavelet transform to obtain EEG_raw_data;

Step S12: de-averaging EEG_raw_data, centering each dimension of the input data to 0, pulling the center of the sample back to the origin of the coordinate system to obtain the data EEG_data1;

Step S13: normalizing the signal amplitude in EEG_data1 to the same range to obtain the data EEG_data2;

Step S14: performing a principal component analysis on EEG_data2 to normalize the amplitude on each characteristic axis of the data to obtain the data set EEG_data. Further, step S2 specifically comprises the following steps:

Step S21: obtaining the one-dimensional convolutional neural network model from the source domain, replacing the structure from the fully connected layer to the output layer, using the one-dimensional convolutional neural network to extract the features of EEG signals of each channel, replacing the structure from the fully connected layer to the output layer with the average pooling layer, outputting the high-level extracted features of EEG signals of each channel, and obtaining the initial model Model_1;

Step S22: taking out some data from the EEG_data database as an EEG_Transfer data set;

Step S23: dividing the EEG_Transfer data set into a training set, a test set and a validation set, each data set is independent and strictly separated from each other;

Step S24: training each training set on the initial model Model_1 and verifying on the validation set;

Step S25: repeating step S23 until all the training sets are traversed, and optimizing the initial parameters through the gradient descent method to obtain the target domain model Model_2;

Step S26: testing Model_2 with the test set to verify the reliability of the target domain model after migration.

Further, step S3 specifically comprises the following steps:

Step S31: inputting the multi-lead EEG signals in the EEG_data data set into each channel of the target domain model Model_2 respectively as multi-channel data to extract emotional features;

Step S32: inputting the cut EEG_data to the convolutional layer, and keeping the output length unchanged after convolution operation by filling zero;

Step S33: inputting the output data of the convolutional layer into the normalization layer for normalization process, and then inputting it into the next activation layer, ReLU function is used as the activation function;

Step S34: stacking the convolutional layer, the normalization layer and the activation layer for several times, and inserting the dropout layer into them, and then randomly inactivating part of the network to avoid over fitting of the network;

Step S35: outputting the high-level features of a single channel through the average pooling layer.

Further, step S4 specifically comprises the following steps:

Step S41: the multi-channel convolutional neural network outputs the feature tensor S for the recursive neural network input of the bi-directional long short-term memory structure Bi-LSTM, the length of the output tensor is the batch size, the width is the length of the time series, and the number of channels is the number of hidden layer units;

Step S42: adding a tan h activation function to the Bi-LSTM internal unit to realize nonlinear mapping and mapping the features to the [0,1] range;

Step S43: initially, choosing the number of hidden layers of the Bi-LSTM network consistent with the length of the input eigenvectors, and then gradually adjusting the initial value setting of the number of hidden units and batch size, and setting the threshold of the number of training cycles;

Step S44: adding L1 regularization, L2 regularization and random deactivation layer to the Bi-LSTM network to avoid over fitting of the network, the network is trained to obtain the time-series feature set S_Time of EEG emotional signals by network training;

Step S45: combining the forward and reverse outputs in the Bi-LSTM network into a set of eigenvectors with constant length, width and number of channels by summing the corresponding positions, so as to obtain the output dimension of the recurrent neural network.

Further, step S5 specifically comprises the following steps:

Step S51: introducing the adaptive attention mechanism, setting a trainable weight vector W and multiplying it with the feature tensor obtained by the Bi-LSTM network to obtain the feature tensor S_Attention with attention weigh;

Step S52: using the weighted feature fusion method, assigning the corresponding weight coefficients to the calculated EEG emotional features of each channel, and then combining to obtain the EEG classification feature tensor S_Classification.

Further, step S6 is specifically as follow:

inputting the classification feature tensor S_Classification to two fully connected layers, and outputting the prediction results of EEG signals on two emotional indicators: valence and arousal by probability classification, the two results are expressed according to SAM emotion category evaluation criteria.

An electronic device comprising a memory, a processor and a computer program stored in the memory and runnable on the processor, characterized in that when the processor executes the program, it realizes the step of the method for realizing a multi-channel convolutional recurrent neural network EEG emotion recognition model using transfer learning.

A non-transitory computer-readable storage medium having a computer program stored thereon, characterized in that when the computer program is executed, it realizes the step of the method for realizing a multi-channel convolutional recurrent neural network EEG emotion recognition model using transfer learning.

Compared with the prior art, the invention and its preferred solution propose to use transfer learning, take the dual-channel one-dimensional convolutional neural network model constructed based on the three heartbeats recognition method as the source domain model, transfer to obtain a multi-channel EEG emotion recognition model with EEG signals as the target domain, and solve the problem of scarcity of EEG data for model training, at the same time, convolutional neural network and recursive neural network are combined to improve the accuracy of emotion prediction of EEG signals.

### BRIEF DESCRIPTION OF THE DRAWINGS

The invention is described in further detail below in combination with the accompanying drawings and specific embodiments:

FIG. 1 is the flow diagram of the model architecture in background technology.

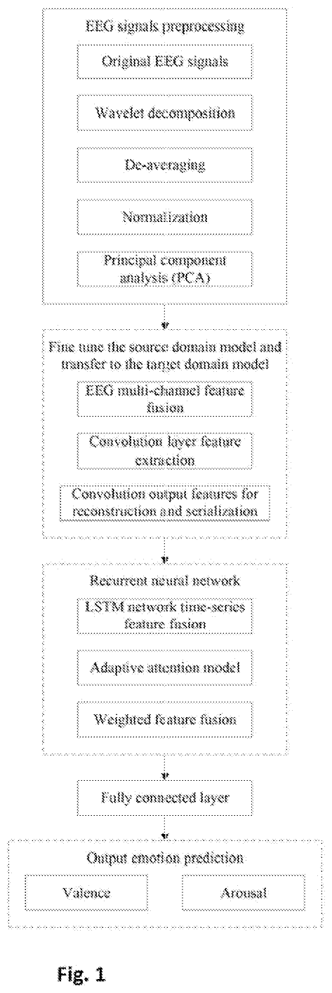

FIG. 2 is the flow diagram of the overall framework of the network model according to the embodiment of the present invention.

### DESCRIPTION OF THE EMBODIMENTS

In order to make the features and advantages of the patent more obvious and easy to understand, the following examples are given for detailed description as follows:

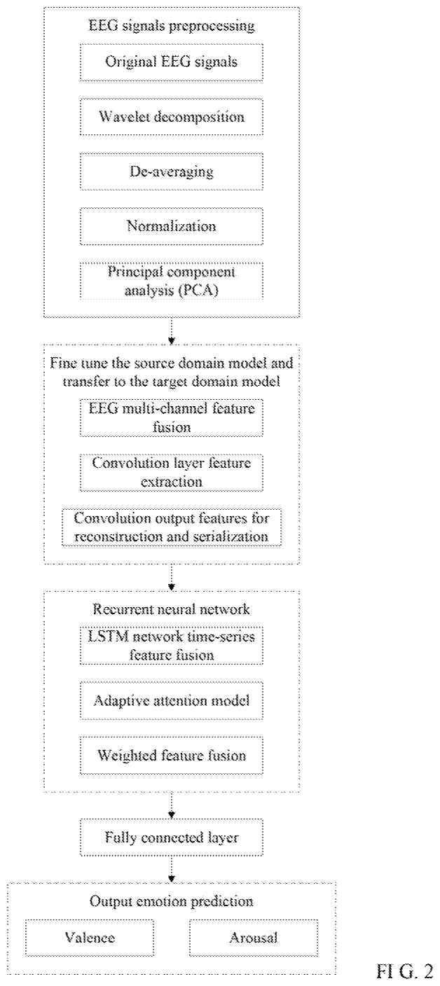

Referring to FIG. 2, this embodiment provides a method of realizing a multi-channel convolutional recurrent neural network EEG emotion recognition model using transfer learning, which takes a dual-channel one-dimensional convolutional neural network model constructed based on three heartbeats recognition method as the source domain model, carries out source domain model training, and realizes automatic classification of arrhythmias; considering the similarities and differences of time-frequency characteristics and data format between EEG and ECG, the solution of realizing multi-channel convolutional recurrent neural network EEG emotion recognition model using transfer learning is feasible; it includes the following steps:

Step S1: obtaining the EEG data set for model training, and selecting the DEAP data set (database for emotion analysis using physiological signals) as the target domain model.

According to the rhythm features of EEG signals, according to its frequency range, the EEG signals can be divided into five basic frequency bands by wavelet decomposition, namely δ Rhythm, θ Rhythm, α Rhythm, β Rhythm, γ Rhythm, different frequency bands retain different EEG features and carry different attributes of emotional information. Effective feature fusion and selecting appropriate classification methods can improve the emotion recognition rate.

In this embodiment, step S1 is specifically as follow: discrete wavelet transforming the EEG signals using the wavelet basis function to obtain different frequency components in the EEG emotional signal.

The EEG signals in the DEAP EEG emotion database are obtained after preprocessing, the sampling frequency is 128 Hz, the EEG emotion signals in the range of 0-64 Hz can be detected by Nyquist sampling theorem. After multi-layer wavelet decomposition of EEG emotional signals, the signals of five rhythm waves in EEG signals can be approximately obtained: δ Rhythm (0.5-3 Hz), θ Rhythm (4-8 Hz), α Rhythm (9-13 Hz), β Rhythm (14-30 Hz), γ Rhythm (above 31 Hz), the “approximate component” obtained in each layer of wavelet decomposition can be divided into low frequency and high frequency, multi-layer decomposition is carried out in this way, so as to achieve the multi-resolution analysis of the original EEG emotional signals. The original EEG emotion signal x(t) can be transformed and decomposed by the following formula.

$$Wf ( a , k ) = {\int }_{- ∞}^{∞} f ( t ) \frac{1}{\sqrt{a}} ψ \frac{( t - k )}{a} d t$$

After wavelet decomposition: δ Rhythm, θ Rhythm, α Rhythm, β Rhythm, γ The rhythm corresponds to approximate component (CA4), detail component (CD4), detail component (CD3) and detail component (CD2) respectively. According to the coefficient component obtained by wavelet decomposition, the signals other than five rhythm waves in EEG signals are filtered to obtain EEG_raw_data.

In order to solve the problem that the amplitude distribution of EEG signals of different individuals is not exactly the same and the order of magnitude is different, the data are de-averaged, the maximum and minimum values in EEG samples are counted by Min-Max normalization standardization method, and the overall distribution is mapped to the range of 0 to 1 according to the two maximum values to obtain a new distribution, for a sample value x, the sample value x′ after standard mapping can be calculated by the following formula.

$${x}_{i}^{′} = \frac{{x}_{i} - {min}_{{x}_{i}}}{{max}_{{x}_{i}} - {min}_{{x}_{i}}}$$

For PCA (principal component analysis) dimensionality reduction of EEG data, first find a direction to maximize the variance after projection, select the first projection direction, and then select the N-th projection direction as required, but some directions overlap. In order to make the projected values represent more original data as much as possible and make it non-linear correlation, covariance matrix Con(a, b) is used to indicate their relevance.

$$Con ( a , b ) = \frac{1}{m} {\sum }_{i = 1}^{m} {a}_{i} {b}_{i}$$

To reduce a group of N-dimensional vectors to M-dimensional, M unit orthogonal bases (modulus 1) need to be selected, so that after the original data is transformed to this group of bases, the covariance between each field is 0, and the variance of the field is as large as possible. The eigenvalues of the covariance matrix and the corresponding eigenvectors λ are obtained, the eigenvectors λ are arranged into a matrix from top to bottom according to the corresponding eigenvalue size, and the first M rows are taken to form a matrix P, Y=PX is the data after dimension reduction to M dimension.

In this embodiment, step S2 is specifically as follow:

1. One-dimensional deep convolutional neural network (1D-CNN) is obtained from the source domain, in order to better observe the connection between leads, the source domain model uses dual-channel one-dimensional convolutional neural network to extract ECG features, and the number of EEG channels is more than that of ECG signals, therefore, the number of channels of the source domain model is adjusted, one-dimensional convolutional neural network is used to extract the features of EEG signals of each channel, the structure from the fully connected layer to the output layer is replaced by the average pooling layer, and the high-level features of EEG signals of each channel are output. The initial model Model_1 is obtained.

2. Take out part of the database data processed in step S2 as EEG_Transfer data set. Firstly, the preprocessed EEG signals is cut to unify the length of each input EEG signal, so as to facilitate the processing of convolutional neural network. The preprocessed EEG signals is cut according to the sampling frequency to keep consistent with the input signal of the source domain model. The zero mean normalization (Z-score) method is used to convert different data into data of the same order of magnitude by using the mean, standard deviation and observation value of the overall data, so as to achieve the purpose of standardization. That is, the original data is subtracted from its mean value and the result is obtained by its standard variance, almost all the processed data are clustered near 0 and have a normal distribution.

3. The data in the EEG_Transfer data set is divided into a training set, a test set and a validation set, each data set is independent and strictly separated from each other; specifically, it can be divided into 10 groups, of which seven groups are selected as the training set, two groups as the validation set and one group as the test set. Seven groups of the training set are trained on the initial model and verified on the validation set, the optimized parameters are obtained by gradient descent method to obtain the target domain model Model_2, and then tested on the test set to obtain the accuracy of the model. Keep the super parameters unchanged, take each group of data as the test set in turn, and the other nine groups of data as the training set and validation set respectively, repeat the above process for 10 times until ten groups of data are used as the test set to verify the reliability of the model. The final model accuracy is obtained by averaging the accuracy of 10 tests.

In this embodiment, step S3 is specifically as follow:

1. The multi-channel EEG data set of the data set not used for transfer learning in the database preprocessed in step S1 is cut as described in step S2. The input matrix of the transferred network is a plurality of EEG signals sequences with a length of 1280, which enter the convolutional layer from multiple channels respectively, and then the zero filling method is used to keep the output length unchanged after convolution operation.

2. The output data enters the normalization layer (Batch Normalization, BN) to normalize the data, in order to speed up the network training and convergence, avoid over fitting, and solve the problems of gradient disappearance and gradient explosion to a certain extent. The strategy of BN layer is to subtract the mean value from the data of each channel and divide it by the variance, so that the data will become a normal distribution with zero mean value and one variance after processing. The core formula process is:

$$μ = \frac{1}{m} {\sum }_{i = 1}^{m} {x}_{i}$$

$${σ}^{2} = \frac{1}{m} {\sum }_{i = 1}^{m} {( {x}_{i} - μ )}^{2}$$

$${y}_{i} = γ ⋆ \frac{{x}_{i} - μ}{\sqrt{{σ}^{2} + ϵ}} + β$$

That is, firstly calculate the mean μ and variance σ² of the channel data, and then use the mean μ and variance σ² to normalize each output x in the channel, and finally multiply each output by γ plus β, the purpose is to restore the normalized features, where γ and β are parameter vectors that can be learned, the size is the input size, and the default values are 1 and 0 respectively.

3. The next layer of BN layer is the activation layer, the ReLU function is used as the activation function, which makes the input and output data no longer a simple linear relationship, and increases the ability of network to learn more complex data. The network superimposes the convolutional layer, normalization layer and activation layer as a combination for several times, and inserts the Dropout layer to randomly inactivate some network units to avoid the network from over fitting. In general, the multi-channel convolutional neural network uses the convolutional layer to extract features, reduces the feature length several times according to the step size, and finally outputs the feature tensor S through the average pooling layer as the input of the recurrent neural network.

In this embodiment, step S4 is specifically as follow:

1. The multi-channel convolutional neural network outputs the feature tensor S with appropriate length, width and number of channels for the input of the bi-directional long short-term memory structure (Bi-Long-Short Term Memory, Bi-LSTM).

LSTM unit controls data flow through forgetting gate, input gate and output gate. The function of forgetting gate is to judge the input vector xₜ of the current timing node and whether the hidden layer output vector hₜ₋₁ from the previous layer needs to be retained, use fₜ to represent the output of the door.

fₜ=ReLU(W_{f}xᵢ+U_{f}hᵢ₋₁+b_{f})

The main function of the input gate iₜ is to determine what information needs to be updated, the cell status C′ₜ records the value to be updated in the next step, and the update cell Cₜ is the update vector of the next input state of the unit.

iₜ=σ(Wᵢ[hᵢ₋₁,xᵢ]+bᵢ)

C′ₜ=tan h·(W_{C}[hₜ₋₁,xₜ]+b_{c})

Cₜ=fₜ*Cₜ₋₁+iₜ*C′ₜ)

2. In the internal unit of LSTM, due to the need of gating, the features need to be limited to be mapped to the [0,1] range, therefore, a sigmoid activation function is added to the forgetting gate, input gate and output gate to realize nonlinear mapping. In the selection of activation function of memory unit, considering that ReLU function is easy to cause gradient explosion in the process of LSTM training, and the unsaturated interval of sigmoid function is narrow, which is easy to cause gradient disappearance, the algorithm uses tan h function as the activation function.

The last gate unit will determine the output of the hidden unit in this step based on the cell state. The gate uses a sigmoid layer to determine which data is output to oₜ, and then determines the output of hidden unit hₜ of the current node together with the cell state activated by tan h function, the output will be used as the input hidden unit of the next layer.

oₜ=σ(Wₒ·[hₜ₋₁,xₜ]+bₒ)

hₜ=oₜ*tan h(Cₜ)

3. In the bidirectional LSTM layer, it is necessary to ensure that the number of features does not exceed the input feature of the convolutional layer regardless of the batch size. Another focus of this layer is the setting of hidden layer units. Generally, the initial selection of this value is consistent with the length S_Lenth of the input eigenvector S, set the initial value based on this method and gradually adjust the number of hidden units. The selection of the above super parameters should follow the rules of GPU parallel computing as much as possible, and select the power of 2.

4. Secondly, it is necessary to determine the initial value of training super parameters. In terms of learning rate, the general value range of this parameter is 0.0001 to 0.01, however, due to the introduction of ReLU activation function, the model should try to avoid selecting a faster learning rate to prevent large-area neuron inactivation. According to the amount of input data in this study, the initial value of batch size is set to AO and continuously improved to test the performance difference of the model. The number of training cycles (epoch) is initially set to E0, which can be determined by observing the generalization performance of the model, or set a threshold E_Threshold, within this threshold, if the model performance cannot continue to improve, the training process will be terminated in advance.

5. Avoid over fitting training of LSTM network, introduce L1 regularization, L2 regularization and Dropout layer, and add a penalty term after the loss function.

6. By summing the corresponding positions, the two groups of forward and reverse outputs in the bidirectional LSTM network are combined into a group of eigenvectors with constant length, width and channel number, so as to obtain the output dimension of the recurrent neural network.

In this embodiment, step S5 is specifically as follow:

1. The soft attention mechanism is used to find the important feature information in the temporal feature set S of a single channel, and the attention coefficient matrix W is obtained by querying key value pairs. Due to the unique mapping relationship between key and value, the attention coefficient can be expressed by the operation results of query value and key. Each input query value will participate in the similarity calculation and normalization of each key value pair. All calculated values are multiplied by the value “Value” and finally accumulated to obtain the attention coefficient. The whole process can be regarded as a process of obtaining important information from a large number of secondary information, in which the importance is related to the attention coefficient. The higher the coefficient, the greater the weight, and L represents the number of key value pairs.

$$Attention ( Query , Source ) = {\sum }_{i = 1}^{L} Similarity ( Query , {Key}_{i} ) ⋆ {Value}_{i} \\ {α}_{i} = softmax ( {Sim}_{i} ) = \frac{{e}^{simi}}{{\sum }_{j = 1}^{L} {e}^{simi}}$$

By setting the trainable weight vector and matrix multiplication with the nonlinear activated tensor, the eigenvector with the length of each time series step as the number of hidden layer units is converted into weight coefficients. The standard weight coefficient matrix α can be obtained by normalizing the weight coefficient matrix through a Softmax activation function, at this time, the length of the matrix is the batch size and the width is the length of the time series. The attention coefficient matrix W can be obtained by weighted summation and resizing of the input tensor of the attention model by reusing matrix α, the length of the matrix is the batch size and the width is the number of hidden units. The adaptive attention model can give different weights to different feature vectors. Before the output of the attention model, an activation layer is added, and the tan h function is chosen as the activation function.

2. According to the attention coefficient matrix W of EEG signals of different channels, the weighted feature fusion method is used to realize the redistribution of features, and the calculated EEG emotional features of each channel are assigned corresponding weight coefficients for combination. Using this method to fuse EEG emotional features, the key is to obtain the weight corresponding to each feature and calculate the weight of the feature to analyze EEG emotional signals. The recognition rate of EEG emotion classification of the i-th EEG feature in N channels is calculated as aᵢ, based on the principle of feedback, the weight wᵢ of each feature is obtained.

$${w}_{i} = \frac{{a}_{i}}{{a}_{1} + {a}_{2} + {a}_{3} + … + {a}_{N - 1} + {a}_{N}} \\ Where {w}_{1} + {w}_{2} + {w}_{3} + … + {w}_{N - 1} + {w}_{N} = 1.$$

By means of weighted feature fusion, the corresponding weight of each corresponding feature in the N channels of EEG emotional signal can be calculated, the emotional feature with the highest weight is the feature with the highest discrimination in the feature set of all channels, and it also contributes the most to emotion classification and recognition. Using the corresponding weight to measure the relevance of each EEG emotion feature to emotion classification, the greater the weight, the stronger the correlation.

3. Focus on extracting the features of single channel EEG signals through adaptive attention mechanism, use weighted feature fusion method to search the features with the highest corresponding contribution rate in multi-channel EEG signals, and reconstruct a complete feature set S_Classify with timing information;

In this embodiment, step S6 is specifically as follow: the output feature vector of bidirectional LSTM network is fused into a complete feature vector S_Classify under the action of adaptive attention mechanism and weighted feature fusion. Finally, it is connected with two full connection layers and probabilistic output. EEG signals are output respectively. The classification possibility of labels is obtained on two indicators: valence and arousal. The prediction results are expressed according to the SAM emotion category evaluation standard, measured by the scoring scale of numbers 1 to 9.

The above method provided by this embodiment can be stored in a computer readable storage medium in a coded form, implemented in the form of a computer program, input the basic parameter information required for calculation through the computer hardware, and output the calculation results.

Those skilled in the art will appreciate that embodiments of the present invention may be provided as methods, systems, or computer program products. Therefore, the present invention may take the form of a full hardware embodiment, a full software embodiment, or an embodiment combining software and hardware aspects. Further, the invention may take the form of a computer program product implemented on one or more computer usable storage media (including but not limited to disk memory, CD-ROM, optical memory, etc.) containing computer usable program codes.

The present invention is described with reference to flow charts and/or block diagrams of methods, equipment (Systems), and computer program products according to embodiments of the present invention. It should be understood that each process and/or block in the flowchart and/or block diagram and the combination of processes and/or blocks in the flowchart and/or block diagram can be realized by computer program instructions. These computer program instructions can be provided to the processor of general-purpose computer, special-purpose computer, embedded processor or other programmable data processing equipment to generate a machine, means for causing instructions executed by a processor of a computer or other programmable data processing device to generate a device for realizing the functions specified in one or more processes of the flowchart and/or one or more blocks of the block diagram.

These computer program instructions may also be stored in a computer-readable memory capable of guiding a computer or other programmable data processing device to work in a specific manner, so that the instructions stored in the computer-readable memory generate a manufacturing product including an instruction device, The instruction device implements the functions specified in one or more processes of the flowchart and/or one or more blocks of the block diagram.

These computer program instructions can also be loaded on a computer or other programmable data processing device so that a series of operation steps are performed on the computer or other programmable device to produce computer implemented processing, Thus, instructions executed on a computer or other programmable device provide steps for implementing the functions specified in one or more processes of the flowchart and/or one or more blocks of the block diagram.

Finally, it should be noted that the above embodiments are only used to illustrate the technical scheme of the invention rather than limit it. Although the invention has been described in detail with reference to the above embodiments, those skilled in the art should understand that the specific embodiment of the invention can still be modified or equivalent replaced, Any modification or equivalent replacement without departing from the spirit and scope of the invention shall be covered within the protection scope of the claims of the invention.

This patent is not limited to the above best embodiment. Anyone can draw other forms of methods to realize multi-channel convolution recursive neural network EEG emotion recognition model by using transfer learning under the Enlightenment of this patent. All equal changes and modifications made according to the scope of the patent application of this invention shall be covered by this patent.

What is claimed is:

1. A method for realizing a multi-channel convolutional recurrent neural network EEG emotion recognition model using transfer learning, characterized in that it comprises the following steps:
Step S1: preprocessing the EEG data set;
Step S2: building a EEG feature extraction pre-training model, using a dual-channel one-dimensional convolutional neural network model constructed based on three heartbeats recognition method as the source domain model for fine-tuning training, using a one-dimensional convolutional neural network to extract the features of EEG signals of each channel, replacing the structure from the fully connected layer to the output layer with the average pooling layer, and outputting the high-level extracted features of EEG signals of each channel to obtain a multi-channel convolutional neural network;
Step S3: using the multi-channel convolutional neural network to extract the features of multi-channel EEG signals in EEG data set;
Step S4: obtaining the high-level features output by the multi-channel convolutional neural network, inputting the feature set into a recurrent neural network for sequence modeling, and outputting the feature set of the recurrent neural network;
Step S5: using an adaptive attention model and weighted feature fusion method to realize the redistribution of feature, and reconstructing to form a complete feature set with timing information;
Step S6: multi-classifying the feature set through the fully connected layer to obtain the prediction results of EEG emotional signals on two indicators: valence and arousal.

2. The method for realizing a multi-channel convolutional recurrent neural network EEG emotion recognition model using transfer learning according to claim 1, characterized in that step S1 specifically comprises the following steps:
Step S11: using wavelet basis function to decompose the EEG signals in the EEG data set by multi-level wavelet transform to obtain EEG_raw_data;
Step S12: de-averaging EEG_raw_data, centering each dimension of the input data to 0, pulling the center of the sample back to the origin of the coordinate system to obtain the data EEG_data1;
Step S13: normalizing the signal amplitude in EEG_data1 to the same range to obtain the data EEG_data2;
Step S14: performing a principal component analysis on EEG_data2 to normalize the amplitude on each characteristic axis of the data to obtain the data set EEG_data.

3. The method for realizing a multi-channel convolutional recurrent neural network EEG emotion recognition model using transfer learning according to claim 2, characterized in that step S2 specifically comprises the following steps:
Step S21: obtaining the one-dimensional convolutional neural network model from the source domain, replacing the structure from the fully connected layer to the output layer, using the one-dimensional convolutional neural network to extract the features of EEG signals of each channel, replacing the structure from the fully connected layer to the output layer with the average pooling layer, outputting the high-level extracted features of EEG signals of each channel, and obtaining the initial model Model_1;
Step S22: taking out some data from the EEG_data database as an EEG_Transfer data set;
Step S23: dividing the EEG_Transfer data set into a training set, a test set and a validation set, each data set is independent and strictly separated from each other;
Step S24: training each training set on the initial model Model_1 and verifying on the validation set;
Step S25: repeating step S23 until all the training sets are traversed, and optimizing the initial parameters through the gradient descent method to obtain the target domain model Model_2;
Step S26: testing Model_2 with the test set to verify the reliability of the target domain model after migration.

4. The method for realizing a multi-channel convolutional recurrent neural network EEG emotion recognition model using transfer learning according to claim 3, characterized in that step S3 specifically comprises the following steps:
Step S31: inputting the multi-lead EEG signals in the EEG_data data set into each channel of the target domain model Model_2 respectively as multi-channel data to extract emotional features;
Step S32: inputting the cut EEG_data to the convolutional layer, and keeping the output length unchanged after convolution operation by filling zero;
Step S33: inputting the output data of the convolutional layer into the normalization layer for normalization process, and then inputting it into the next activation layer, ReLU function is used as the activation function;
Step S34: stacking the convolutional layer, the normalization layer and the activation layer for several times, and inserting the dropout layer into them, and then randomly inactivating part of the network to avoid over fitting of the network;
Step S35: outputting the high-level features of a single channel through the average pooling layer.

5. The method for realizing a multi-channel convolutional recurrent neural network EEG emotion recognition model using transfer learning according to claim 4, characterized in that step S4 specifically comprises the following steps:
Step S41: the multi-channel convolutional neural network outputs the feature tensor S for the recursive neural network input of the bi-directional long short-term memory structure Bi-LSTM, the length of the output tensor is the batch size, the width is the length of the time series, and the number of channels is the number of hidden layer units;
Step S42: adding a tan h activation function to the Bi-LSTM internal unit to realize nonlinear mapping and mapping the features to the [0,1] range;
Step S43: initially, choosing the number of hidden layers of the Bi-LSTM network consistent with the length of the input eigenvectors, and then gradually adjusting the initial value setting of the number of hidden units and batch size, and setting the threshold of the number of training cycles;
Step S44: adding L1 regularization, L2 regularization and random deactivation layer to the Bi-LSTM network to avoid over fitting of the network, the network is trained to obtain the time-series feature set S_Time of EEG emotional signals by network training;
Step S45: combining the forward and reverse outputs in the Bi-LSTM network into a set of eigenvectors with constant length, width and number of channels by summing the corresponding positions, so as to obtain the output dimension of the recurrent neural network.

6. The method for realizing a multi-channel convolutional recurrent neural network EEG emotion recognition model using transfer learning according to claim 5, characterized in that step S5 specifically comprises the following steps:
Step s5: introducing the adaptive attention mechanism, setting a trainable weight vector W and multiplying it with the feature tensor obtained by the Bi-LSTM network to obtain the feature tensor S_Attention with attention weigh;
Step S52: using the weighted feature fusion method, assigning the corresponding weight coefficients to the calculated EEG emotional features of each channel, and then combining to obtain the EEG classification feature tensor S_Classification.

7. The method for realizing a multi-channel convolutional recurrent neural network EEG emotion recognition model using transfer learning according to claim 5, characterized in that step S6 is specifically as follow:
inputting the classification feature tensor S_Classification to two fully connected layers, and outputting the prediction results of EEG signals on two emotional indicators: valence and arousal by probability classification, the two results are expressed according to SAM emotion category evaluation criteria.

8. An electronic device comprising a memory, a processor and a computer program stored in the memory and runnable on the processor, characterized in that when the processor executes the program, it realizes the step of the method for realizing a multi-channel convolutional recurrent neural network EEG emotion recognition model using transfer learning according to claim 1.

9. An electronic device comprising a memory as claimed in claim 8, characterized in that step S1 specifically comprises the following steps:
Step S11: using wavelet basis function to decompose the EEG signals in the EEG data set by multi-level wavelet transform to obtain EEG_raw_data;
Step S12: de-averaging EEG_raw_data, centering each dimension of the input data to 0, pulling the center of the sample back to the origin of the coordinate system to obtain the data EEG_data1;
Step S13: normalizing the signal amplitude in EEG_data1 to the same range to obtain the data EEG_data2;
Step S14: performing a principal component analysis on EEG_data2 to normalize the amplitude on each characteristic axis of the data to obtain the data set EEG_data.

10. An electronic device comprising a memory as claimed in claim 8, characterized in that step S2 specifically comprises the following steps:
Step S21: obtaining the one-dimensional convolutional neural network model from the source domain, replacing the structure from the fully connected layer to the output layer, using the one-dimensional convolutional neural network to extract the features of EEG signals of each channel, replacing the structure from the fully connected layer to the output layer with the average pooling layer, outputting the high-level extracted features of EEG signals of each channel, and obtaining the initial model Model_1;
Step S22: taking out some data from the EEG_data database as an EEG Transfer data set;
Step S23: dividing the EEG_Transfer data set into a training set, a test set and a validation set, each data set is independent and strictly separated from each other;
Step S24: training each training set on the initial model Model_1 and verifying on the validation set;
Step S25: repeating step S23 until all the training sets are traversed, and optimizing the initial parameters through the gradient descent method to obtain the target domain model Model_2;
Step S26: testing Model_2 with the test set to verify the reliability of the target domain model after migration.

11. An electronic device comprising a memory as claimed in claim 8, characterized in that step S3 specifically comprises the following steps:
Step S31: inputting the multi-lead EEG signals in the EEG_data data set into each channel of the target domain model Model_2 respectively as multi-channel data to extract emotional features;
Step S32: inputting the cut EEG_data to the convolutional layer, and keeping the output length unchanged after convolution operation by filling zero;
Step S33: inputting the output data of the convolutional layer into the normalization layer for normalization process, and then inputting it into the next activation layer, ReLU function is used as the activation function;
Step S34: stacking the convolutional layer, the normalization layer and the activation laver for several times, and inserting the dropout laver into them, and then randomly inactivating part of the network to avoid over fitting of the network;
Step S35: outputting the high-level features of a single channel through the average pooling layer.

12. An electronic device comprising a memory as claimed in claim 8, characterized in that step S4 specifically comprises the following steps:
Step S41: the multi-channel convolutional neural network outputs the feature tensor S for the recursive neural network input of the bi-directional long short-term memory structure Bi-LSTM, the length of the output tensor is the batch size, the width is the length of the time series, and the number of channels is the number of hidden laver units;
Step S42: adding a tan h activation function to the Bi-LSTM internal unit to realize nonlinear mapping and mapping the features to the [0,1] range;
Step S43: initially, choosing the number of hidden layers of the Bi-LSTM network consistent with the length of the input eigenvectors, and then gradually adjusting the initial value setting of the number of hidden units and batch size, and setting the threshold of the number of training cycles;
Step S44: adding L1 regularization, L2 regularization and random deactivation layer to the Bi-LSTM network to avoid over fitting of the network, the network is trained to obtain the time-series feature set S_Time of EEG emotional signals by network training;
Step S45: combining the forward and reverse outputs in the Bi-LSTM network into a set of eigenvectors with constant length, width and number of channels by summing the corresponding positions, so as to obtain the output dimension of the recurrent neural network.

13. An electronic device comprising a memory as claimed in claim 8, characterized in that step S5 specifically comprises the following steps:
Step s51: introducing the adaptive attention mechanism, setting a trainable weight vector W and multiplying it with the feature tensor obtained by the Bi-LSTM network to obtain the feature tensor S_Attention with attention weigh;
Step S52: using the weighted feature fusion method, assigning the corresponding weight coefficients to the calculated EEG emotional features of each channel, and then combining to obtain the EEG classification feature tensor S_Classification.

14. An electronic device comprising a memory as claimed in claim 8, characterized in that step S6 is specifically as follow:
inputting the classification feature tensor S_Classification to two fully connected layers, and outputting the prediction results of EEG signals on two emotional indicators: valence and arousal by probability classification, the two results are expressed according to SAM emotion category evaluation criteria.

15. A non-transitory computer-readable storage medium having a computer program stored thereon, characterized in that when the computer program is executed, it realizes the step of the method for realizing a multi-channel convolutional recurrent neural network EEG emotion recognition model using transfer learning according to claim 1.

16. A non-transitory computer-readable storage medium having a computer program stored thereon as claimed in claim 15, characterized in that step S1 specifically comprises the following steps:
Step S11: using wavelet basis function to decompose the EEG signals in the EEG data set by multi-level wavelet transform to obtain EEG_raw_data;
Step S12: de-averaging EEG_raw_data, centering each dimension of the input data to 0, pulling the center of the sample back to the origin of the coordinate system to obtain the data EEG_data1;
Step S13: normalizing the signal amplitude in EEG_data1 to the same range to obtain the data EEG_data2;
Step S14: performing a principal component analysis on EEG_data2 to normalize the amplitude on each characteristic axis of the data to obtain the data set EEG_data.

17. A non-transitory computer-readable storage medium having a computer program stored thereon as claimed in claim 15, characterized in that step S2 specifically comprises the following steps:
Step S21: obtaining the one-dimensional convolutional neural network model from the source domain, replacing the structure from the fully connected layer to the output layer, using the one-dimensional convolutional neural network to extract the features of EEG signals of each channel, replacing the structure from the fully connected laver to the output laver with the average pooling laver, outputting the high-level extracted features of EEG signals of each channel, and obtaining the initial model Model_1;
Step S22: taking out some data from the EEG_data database as an EEG Transfer data set;
Step S23: dividing the EEG_Transfer data set into a training set, a test set and a validation set, each data set is independent and strictly separated from each other;
Step S24: training each training set on the initial model Model_1 and verifying on the validation set;
Step S25: repeating step S23 until all the training sets are traversed, and optimizing the initial parameters through the gradient descent method to obtain the target domain model Model_2;
Step S26: testing Model_2 with the test set to verify the reliability of the target domain model after migration.

18. A non-transitory computer-readable storage medium having a computer program stored thereon as claimed in claim 15, characterized in that step S3 specifically comprises the following steps:
Step S31: inputting the multi-lead EEG signals in the EEG_data data set into each channel of the target domain model Model_2 respectively as multi-channel data to extract emotional features;
Step S32: inputting the cut EEG_data to the convolutional layer, and keeping the output length unchanged after convolution operation by filling zero;
Step S33: inputting the output data of the convolutional laver into the normalization layer for normalization process, and then inputting it into the next activation laver, ReLU function is used as the activation function;
Step S34: stacking the convolutional layer, the normalization layer and the activation layer for several times, and inserting the dropout layer into them, and then randomly inactivating part of the network to avoid over fitting of the network;
Step S35: outputting the high-level features of a single channel through the average pooling layer.

19. A non-transitory computer-readable storage medium having a computer program stored thereon as claimed in claim 15, characterized in that step S4 specifically comprises the following steps:
Step S41: the multi-channel convolutional neural network outputs the feature tensor S for the recursive neural network input of the bi-directional long short-term memory structure Bi-LSTM, the length of the output tensor is the batch size, the width is the length of the time series, and the number of channels is the number of hidden layer units;
Step S42: adding a tan h activation function to the Bi-LSTM internal unit to realize nonlinear mapping and mapping the features to the [0,1] range;
Step S43: initially, choosing the number of hidden layers of the Bi-LSTM network consistent with the length of the input eigenvectors, and then gradually adjusting the initial value setting of the number of hidden units and batch size, and setting the threshold of the number of training cycles;
Step S44: adding L1 regularization, L2 regularization and random deactivation layer to the Bi-LSTM network to avoid over fitting of the network, the network is trained to obtain the time-series feature set S_Time of EEG emotional signals by network training;
Step S45: combining the forward and reverse outputs in the Bi-LSTM network into a set of eigenvectors with constant length, width and number of channels by summing the corresponding positions, so as to obtain the output dimension of the recurrent neural network.

20. A non-transitory computer-readable storage medium having a computer program stored thereon as claimed in claim 15, characterized in that step S5 specifically comprises the following steps:
Step s51: introducing the adaptive attention mechanism, setting a trainable weight vector W and multiplying it with the feature tensor obtained by the Bi-LSTM network to obtain the feature tensor S_Attention with attention weigh;
Step S52: using the weighted feature fusion method, assigning the corresponding weight coefficients to the calculated EEG emotional features of each channel, and then combining to obtain the EEG classification feature tensor S_Classification.

21. A non-transitory computer-readable storage medium having a computer program stored thereon as claimed in claim 15, characterized in that step S6 is specifically as follow:
inputting the classification feature tensor S_Classification to two fully connected layers, and outputting the prediction results of EEG signals on two emotional indicators; valence and arousal by probability classification, the two results are expressed according to SAM emotion category evaluation criteria.
